(19) United States
(12) Patent Application Publication
(10) Pub. No.: US 2019/0248269 A1
(43) Pub. Date: Aug. 15, 2019

(54) CARGO RESTRAINT SYSTEM

(71) Applicant: Goodrich Corporation, Charlotte, NC (US)

(72) Inventors: Vinodkumar Shivalinga, Bangalore (IN); Venkatesh Chitragar, Bangalore (IN)

(21) Appl. No.: 15/962,033

(22) Filed: Apr. 25, 2018

(30) Foreign Application Priority Data
Feb. 15, 2018 (IN) 201811005754

(51) Int. Cl. B60P 7/13; B64D 9/00; B60P 7/08; E05B 47/00

(52) U.S. Cl. CPC B60P 7/13; B64D 9/003; E05B 2047/002; E05B 47/0012; E05B 2047/0067; B60P 7/0807

(57) ABSTRACT

A cargo restraint system is adapted to lock-down a plurality of cargo containers in a cargo bay. The cargo restraint system includes a plurality of lock-down assemblies and a control panel. The plurality of lock-down assemblies each include a structural frame, a first pawl, and an electric motor supported by the structural frame. The first pawl is adapted to pivot about a pivot axis between a latched position for lock-down of at least one of the plurality of cargo containers and an unlatched position. The electric motor is adapted to drive the first pawl between the latched and unlatched positions. The control panel is configured to control the positioning of the plurality of lock-down assemblies via the respective electric motors.

### CROSS REFERENCE TO RELATED APPLICATIONS

This application claims the benefit of IN Application number 201811005754 filed Feb. 15, 2018, which is incorporated herein by reference in its entirety.

### BACKGROUND

The present disclosure relates to a cargo restraint system and, more particularly, to a motorized cargo restraint system that may be remotely controlled and operated.

Tradition cargo restraint systems may include multiple lock-down assemblies generally secured to a floor of a cargo bay and used to restrain multiple cargo containers. The lock-down assemblies are operated manually, requiring an operated to manually move lock pawls of the lock-down assemblies into and out of a restraint position. Because of close quarters within cargo bays, each lock-down assembly must be inspected individually to assure its correct positioning, often before the next cargo container is loaded into the cargo bay. Such inspections may be prone to human error. Moreover, maintenance checks on the lock-down assemblies may be cumbersome and must be conducted one-by-one for each assembly.

### SUMMARY

A cargo restraint system adapted to lock-down a plurality of cargo containers in a cargo bay according to one, non-limiting, embodiment of the present disclosure includes a plurality of lock-down assemblies each including a structural frame, a first pawl pivotally engage to the structural frame and adapted to pivot about a pivot axis between a latched position for lock-down of at least one of the plurality of cargo containers and an unlatched position, and an electric motor supported by the structural frame and adapted to drive the first pawl between the latched and unlatched positions; and a control panel configured to control the positioning of the plurality of lock-down assemblies via the respective electric motors.

Additionally to the foregoing embodiment, the first pawl does not project above the structural frame when in the unlatched position, and projects above the structural frame when in the latched position.

In the alternative or additionally thereto, in the foregoing embodiment, the cargo restraint system includes an elongated tray extending along a centerline, attached to the cargo bay, and generally disposed below the plurality of cargo containers, wherein the plurality of lock-down assemblies are supported by and located in the elongated tray.

In the alternative or additionally thereto, in the foregoing embodiment, the centerline is disposed perpendicular to the pivot axis of each one of the plurality of lock-down assemblies.

In the alternative or additionally thereto, in the foregoing embodiment, the cargo restraint system includes a plurality of rollers spaced along and rotationally engaged to the tray for rolling upon the plurality of cargo containers, wherein each roller of the plurality of rollers include a rotation axis disposed normal to the centerline.

In the alternative or additionally thereto, in the foregoing embodiment, each one of the plurality of lock down assemblies include a position sensor configured to output a position signal to the control panel and indicative of the latched and unlatched positions.

In the alternative or additionally thereto, in the foregoing embodiment, the control panel includes a user display configured to display the latched and unlatched positions of the plurality of lock-down assemblies.

In the alternative or additionally thereto, in the foregoing embodiment, each one of the plurality of lock down assemblies include a second pawl pivotally engaged to the structural frame, and adapted to pivot with the first pawl between the latched and unlatched positions.

In the alternative or additionally thereto, in the foregoing embodiment, the first pawl is adapted to lock-down a first cargo container of the plurality of cargo containers when in the latch position, and the second pawl is adapted to lock-down a second cargo container located adjacent to the first cargo container when in the latched position.

A cargo lock-down assembly according to another, non-limiting, embodiment includes a structural frame; an electric motor supported by the structural frame; a first pawl pivotally engaged to the structural frame; and a drive device operably connected between the electric motor and the first pawl for pivoting the first pawl between latched and unlatch position.

Additionally to the foregoing embodiment, the cargo lock-down assembly includes a second pawl pivotally engaged to the structural frame and operably connected to the drive device, and constructed to move with the first pawl between the latched and unlatched positions.

In the alternative or additionally thereto, in the foregoing embodiment, the cargo lock-down assembly includes a position sensor adapted to detect the latched and unlatched positions.

In the alternative or additionally thereto, in the foregoing embodiment, the cargo lock-down assembly includes a roller rotationally engaged to the structural frame about a rotation axis, and projecting in-part above the structural frame.

In the alternative or additionally thereto, in the foregoing embodiment, the electric motor is disposed radially inward from the roller.

In the alternative or additionally thereto, in the foregoing embodiment, the electric motor includes a rotor centered to the rotation axis.

In the alternative or additionally thereto, in the foregoing embodiment, the drive device is a gear train including a first freewheel gear engaged to the first pawl and a second freewheel gear engaged to the second pawl, and the electric motor is constructed to drive the first freewheel gear when moving toward one of the latched and unlatched positions as the second freewheel gear freewheels, and the electric motor is constructed to drive the second freewheel gear when moving toward the other of the latched and unlatched positions as the first freewheel gear freewheels.

In the alternative or additionally thereto, in the foregoing embodiment, the cargo lock-down assembly includes a torsion spring engaged between the first and second pawls and adapted to cause simultaneous pivoting of the first and second pawls between the latched and unlatched positions.

In the alternative or additionally thereto, in the foregoing embodiment, the electric motor is reversible.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of a cargo restraint system in a cargo bay as one, non-limiting, embodiment of the present disclosure;

FIG. 2 is an enlarged, partial, side view of a lock-down assembly of the cargo restraint system in a latched position and restraining cargo containers;

FIG. 3 is a perspective view of the lock-down assembly in the latched position;

FIG. 4 is a disassembled perspective view of the lock-down assembly;

FIG. 5 is a partial disassembled, perspective, view of the lock-down assembly;

FIG. 6 is a perspective view of a side member of a structural frame of the lock-down assembly;

FIG. 7 is a perspective view of a base of a second side member of the structural frame;

FIG. 8 is a side view of the lock-down assembly in the latched position and with a cover of the second side member removed to show internal detail;

FIG. 9 is a side view of the lock-down assembly in an unlatched position and similar in perspective to FIG. 8;

FIG. 10 is a partial top view of the lock-down assembly in the unlatched position, and with the second side member removed to show internal detail;

FIG. 11 is a disassembled, perspective, view of a freewheel gear of a drive device of the lock-down assembly; and

FIG. 12 is a schematic of the cargo restraint system.

### DETAILED DESCRIPTION

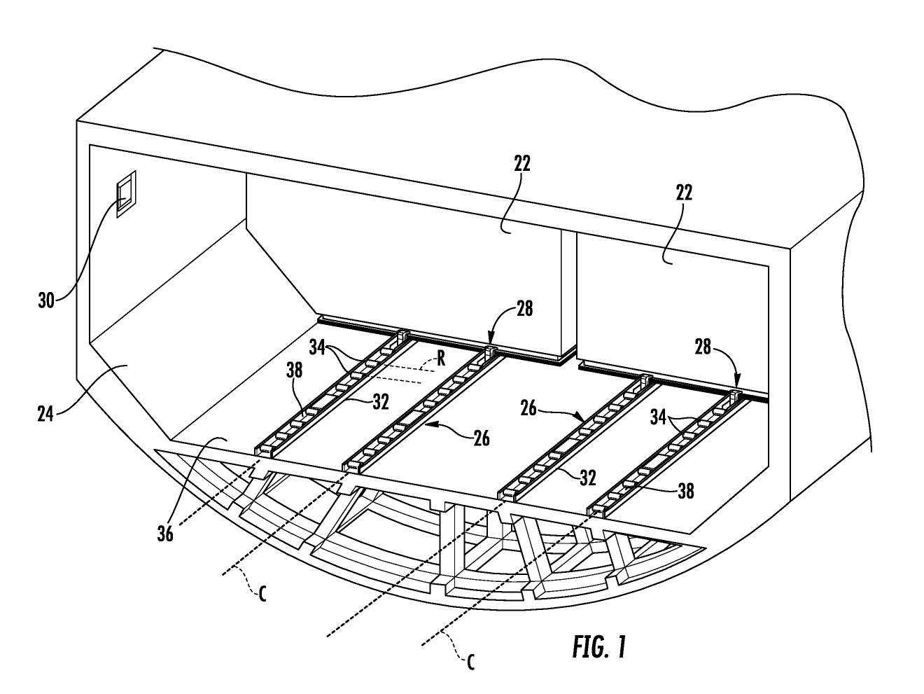

Referring to FIG. 1, a cargo restraint system 20 is adapted to lock-down a plurality of cargo containers 22 that may be in a cargo bay 24. In one embodiment, the cargo containers 22 may be aviation cargo containers, and the cargo bay 24 may be a bay within an aircraft. In other embodiments, the cargo containers 22 may be transport containers designed to be transported within, or on, bays 24 that are part of railway cars, roadway trailers (i.e., trucking), and/or nautical ships.

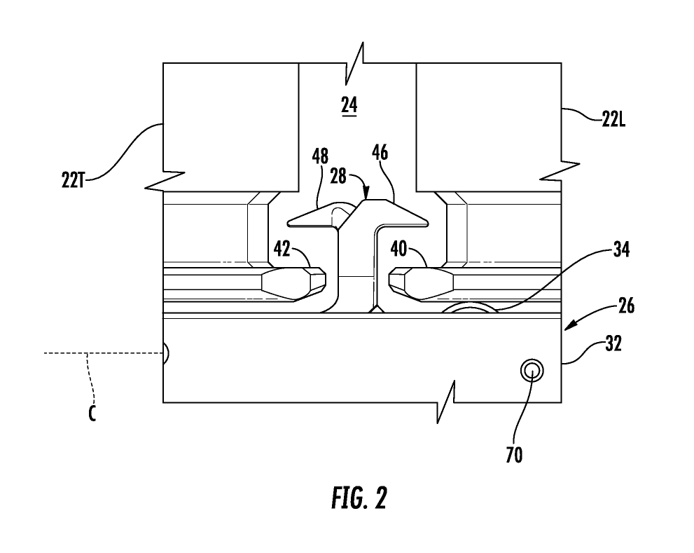

Referring to FIGS. 1 and 2, the cargo restraint system 20 may include a plurality of tray assemblies 26 that may be elongated, a plurality of lock-down assemblies 28, and a control panel 30. In one embodiment, each tray assembly 26 may include a tray 32 and a plurality of rollers 34. The tray 32 may generally be integrated into, and below, a floor 36 of the cargo bay 26. Each tray 32 may include, and extends along, a centerline C. The trays 32 may be aligned side-by-side, such that the centerlines C are generally parallel to one another and spaced radially apart. Each tray 32 includes boundaries that define a channel 38 in fluid communication through the floor 36. That is, each channel 38 communicates radially through the floor 36 with respect to the centerline C. It is contemplated and understood that the tray assemblies 26 may not be part of the cargo restraint system 20, and instead, may be an integral part of the cargo bay 24.

The rollers 34 of the tray assembly 26 are rotationally supported by the tray 32, and each include a rotational axis R that is substantially normal to the centerline C of the respective tray 32. The rollers 34 may be positioned such that a portion is located above the cargo bay floor 36. The cargo containers 22 may be slightly elevated above the floor 36 via the rollers 34 for easy, friction free, loading and unloading of the cargo containers 22 from the cargo bay 24.

Referring to FIG. 2, any number of the plurality of lock-down assemblies 28 may be located in each channel 34, and axially spaced along and supported by each tray 26. In one embodiment, the lock-down assemblies 28 may be substantially located beneath, and extends between a rearward lip 40 of a first or leading container 22L, and a forward lip 42 of a rearward, or trailing container 22T of the plurality of cargo containers 22 (see FIG. 2). That is, each container 22 may include forward and rearward lips 42, 40 such that when the cargo bay 24 is loaded, the plurality of containers 22 may be aligned and secured as a train of containers, locked-down by a multitude of lock-down assemblies 28.

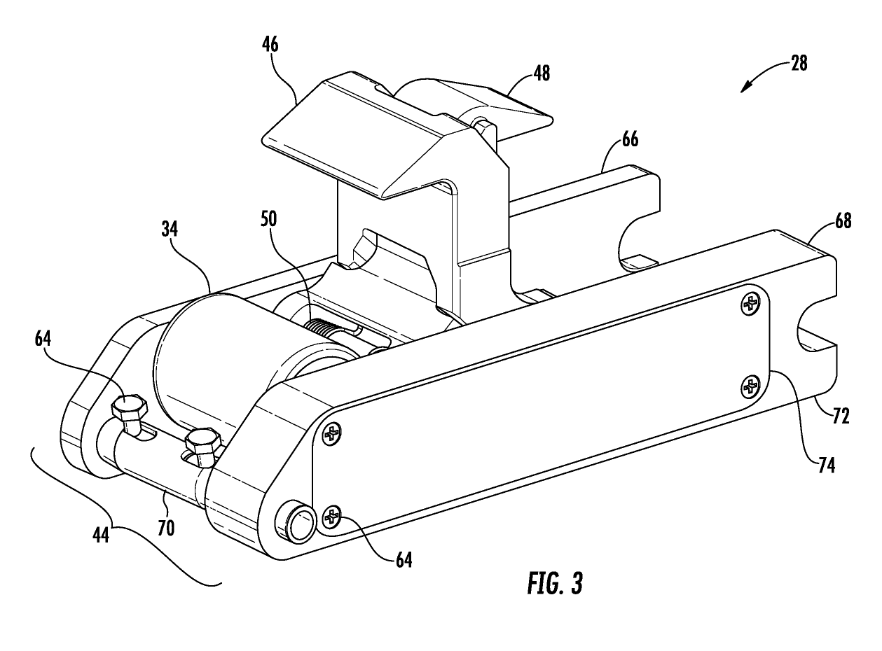

Referring to FIGS. 3 through 5, each lock-down assembly 28 may include a structural frame 44, opposite pawls 46, 48 (i.e., latches), a biasing member 50, an electric motor 52, a drive device 54 (e.g., gear drive device, or gear train), at least one position sensor 56, a local control unit, or power relay, 58, two axles 60, 62 that may or may not be bisected, and a variety of fasteners, bushings, washers, clip rings, and other components 64 for securing the assembly 28 together. The structural frame 44 may include opposing side members 66, 68 and at least one cross member 70 for rigid attachment of the side members 66, 68. Each side member 66, 68 may be elongated, longitudinally extends along the centerline C of the tray 32, and may not project above the tray 32 and/or floor 36.

The biasing member 50 may be at least one spring (i.e., two illustrated). In one embodiment, the biasing member 50 may be a torsion spring. The biasing member 50 functions to keep both pawls 46, 48 in general contact with one-another, and ensures relative motion between the two pawls. In one embodiment, the biasing member 50 may coil about both axles 60, 62.

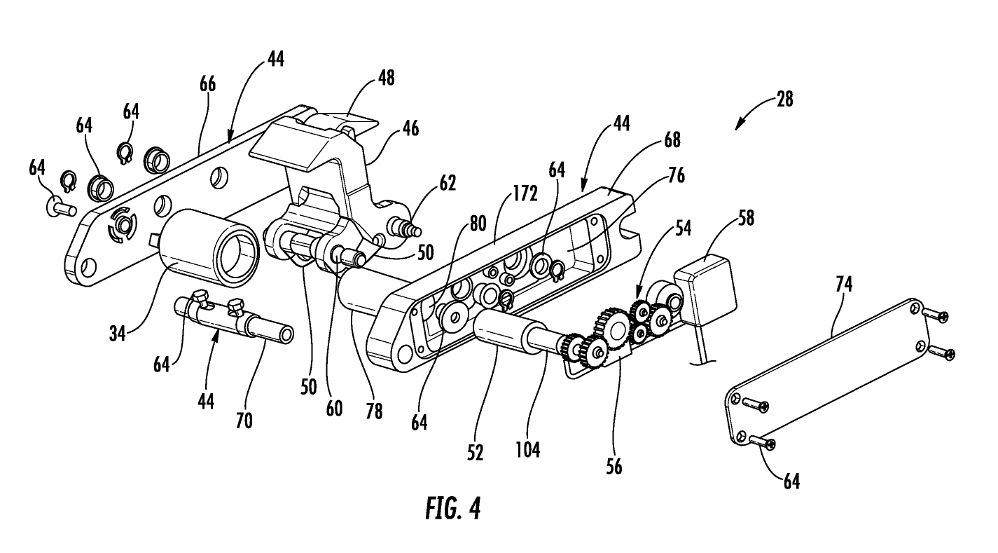

Referring to FIGS. 4, 6, and 7, the side member 68 may generally be a housing having a base 72 and a cover 74 detachably engaged to the base 72. Together, the base 72 and the cover 74 include boundaries that define a chamber 76 for housing the drive device 54, the local control unit 58, and the position sensor 56. The side member 68 may further include a hollow member 78 that projects from the base 72 and toward the side member 66 for attachment thereto. The hollow member 78 may be tubular and centered about an axis R disposed substantially normal to the centerline C. The hollow member 78 may include an internal surface 82 that faces radially inward, is circumferentially continuous, and defines a cavity 80 for receipt of the electric motor 52. The cavity 80 is in fluid communication with the chamber 76.

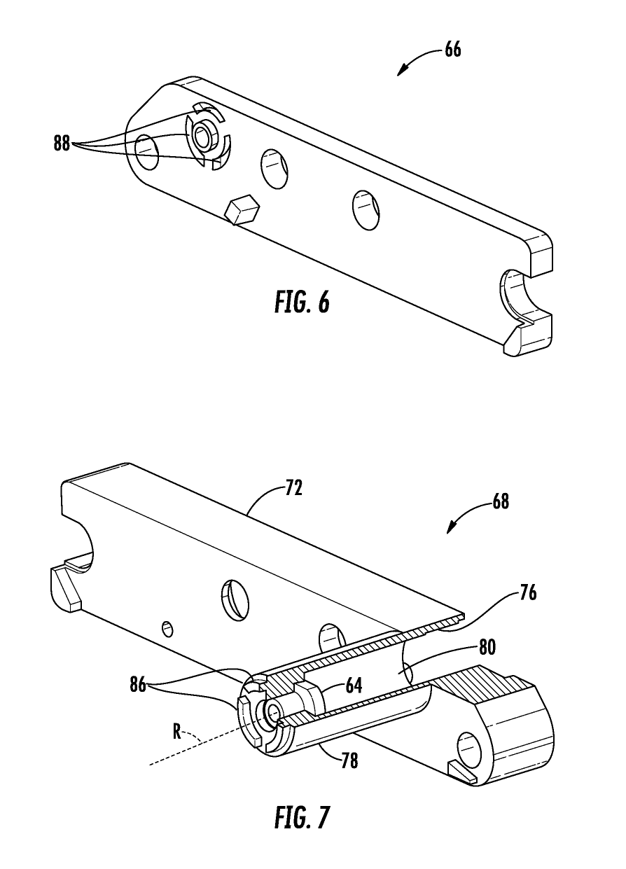

An external surface 84 of the hollow member 78 faces radially outward and is circumferentially continuous. In one embodiment, the external surface 84 may be cylindrical for mounting of the roller 34 (i.e., or roller bushing). Generally at a distal end, the hollow member 78 may include a plurality of projections 86 that may project axially and are spaced circumferentially from one another for receipt into respective indexing pockets 88 in the side member 66 (see FIG. 6). As constructed, the hollow member 78 may generally serve two functions, the first being a housing to secure the electric motor 52, and a support structure upon which a roller 34 is mounted. In one embodiment, the rotational axis R may co-extend with the rotational axis of the electric motor 52.

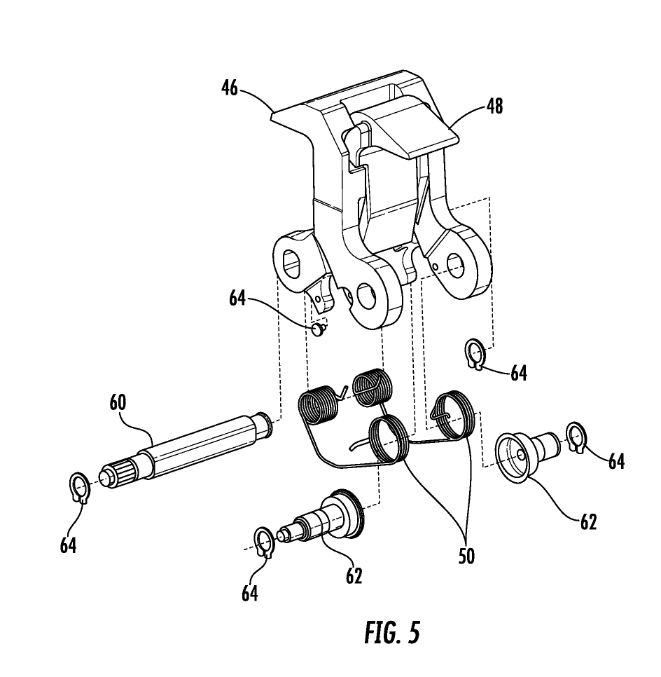

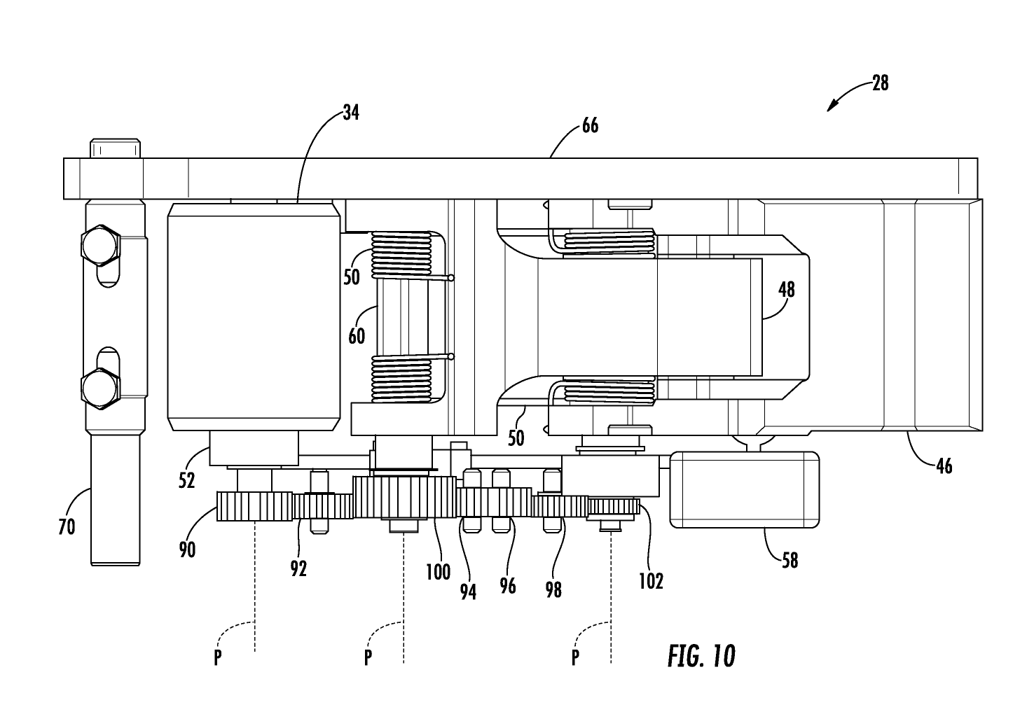

Referring again to FIGS. 4 and 5, the axles 60, 62 each extend along respective pivot axes P. Opposite ends of the axle 60 are rotationally attached and supported by the respective side member 66 and the base 72 of the side member 68. Opposite ends of the axle 62 are rotationally attached and supported by the respective side member 66 and the base 72 of the side member 68 (also see FIG. 10).

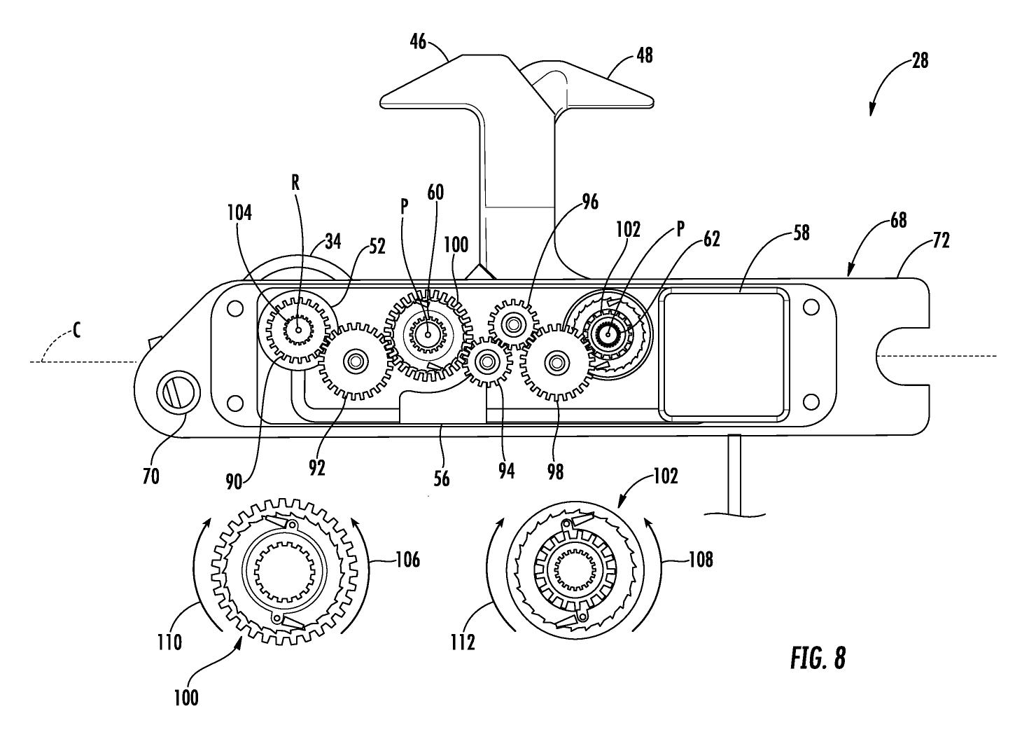

Referring to FIGS. 8 through 10, the drive device 54 is illustrated as a gear train, and generally functions to drive the pawls 46, 48 into latched and unlatched positions upon operation of the electric motor 52. The device 54 may include a motor gear 90, a plurality of transfer gears (i.e., four illustrated as 92, 94, 96, 98), and two freewheel gears 100, 102. In one embodiment, the motor gear 90 is connected (e.g., splined) to an end of a rotor, or motor shaft, 104 of the electric motor 52. The freewheel gear 100 is connected (e.g., splined) to the end of the axle 60, and the freewheel gear 102 is connected to the end of the axle 62. The motor gear 90 is meshed for rotation to the transfer gear 92. The transfer gear 92 is meshed for rotation to the freewheel gear 100. The freewheel gear 100 is meshed for rotation to the transfer gear 94. The transfer gear 94 is meshed for rotation to the transfer gear 96. The transfer gear 96 is meshed for rotation to the transfer gear 98, and the transfer gear 98 is meshed for rotation to the freewheel gear 102. It is contemplated and understood that the latched position may be an erect position, and the unlatched position may be a retracted position with respect to orientation of the pawls 46, 48.

In operation of the lock-down assembly 28, the drive device 54 functions to transmit rotary motion from the motor rotor 104 to the inner and outer pawls 48, 46. The gears of the drive device 54 are arranged such that the freewheel gear 100 connected to the inner pawl 48, and the freewheel gear 102 connected to the outer pawl 46 may rotate in the same direction as the motor gear 90. In one embodiment, the gear ratio between the freewheel gears 100, 102 may be about 1:2. This ratio reflects the difference in sweep angles of the inner and outer pawls 48, 46 as the pawls pivot between latched and unlatched positions. More specifically, and in one embodiment, the outer pawl sweep angle may be twice the inner pawl sweep angle.

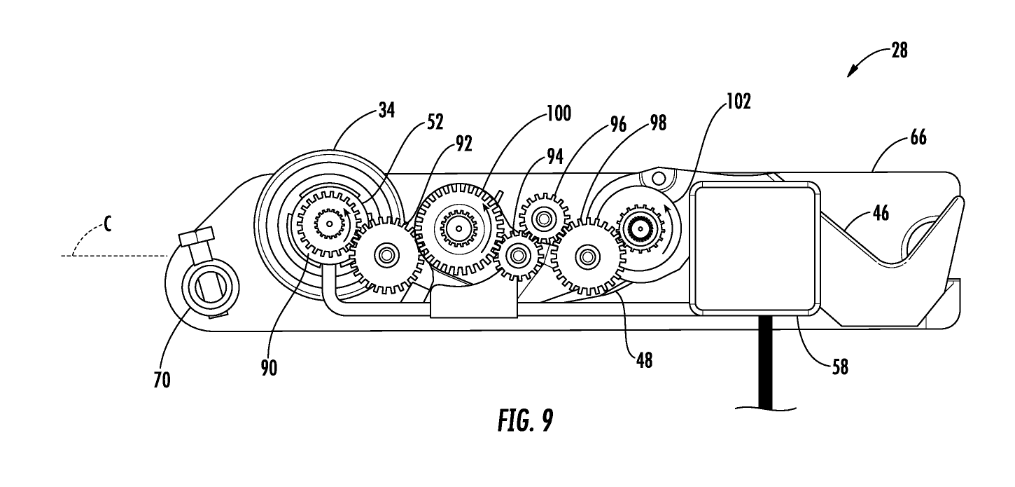

Referring to FIG. 8, the freewheel gear 100 connected to the outer pawl 48 is adapted to freewheel in what may be a counter-clockwise, freewheeling, direction (see arrow 106) as the lock-down assembly 28 moves from the unlatched position (i.e., retracted position, see FIGS. 9 and 10), and toward the latched position (i.e., erected position, see FIG. 8) to restrain the leading and trailing cargo containers 22L, 22T (see FIG. 2). During this motion, the power from the rotor 104 of the electric motor 52 is transferred to the axle 62 connected to the outer pawl 46 via the freewheel gear 102 that may rotate in a counter-clockwise, drive, direction (see arrow 108).

As the lock-down assembly 28 moves from the latched position to unlatched position to at least partially un-restrain the cargo containers 22L, 22T, the turning direction of the motor rotor 104 is reversed. The rotor power is then transferred to the freewheel gear 100 connected to the axle 60 attached to the inner pawl 48. During this retraction motion, the freewheel gear 100 may rotate in a clockwise, drive, direction (see arrow 110), and the freewheel gear 102 associated with the outer pawl 46 may rotate in a clockwise, freewheel, direction (see arrow 112). Whether the lock-down assembly 28 is moving toward the latched position, or the unlatched position, only one pawl is power (i.e., driven) via the electric motor 52 at one time. The other pawl is adapted to follow the driven pawl due to the relative motion between the pawls because of the biasing element(s) 50 (e.g., torsion springs). In a scenario where there is a power failure, and/or the electric motor 52 is inoperative, the pawls 46, 48 may be manually operated.

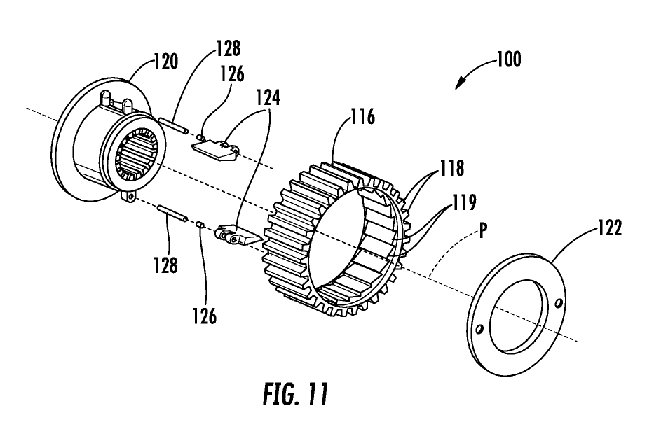

Referring to FIG. 11, an over running clutch is illustrated. This clutch may be one example of one, or both, of the freewheel gears 100, 102. It is contemplated and understood that any type of over running clutches, known by one skilled in the art of clutches may be applied. In this example, the freewheel gear 100 associated with the inner pawl 48, may include an annular sprocket 116 that carries a plurality of external gear teeth 118 and a plurality of internal ratchet teeth 119, a sprocket housing 120, a collar 122, sprocket pawls 124, sprocket pawl springs 126 and pins 128. The sprocket housing 120 includes internal splines that engage splines on the axle 60. The spring 126 may be a torsion spring and is adapted to push the sprocket pawl 124 away from the pivot axis P. The internal ratchet teeth 119 of the sprocket 116 are constructed to engage the pawls 124 to transfer motion.

During assembly, and when the sprocket 116 is inserted in the sprocket housing 120, the collar 122 is fastened to the housing 120. Although not illustrated, ball bearing may be used to reduce friction between the sprocket 116 and the housing 120. One difference between the freewheel gears 100, 102, is that the sprocket pawls 124 are oriented in different directions causing only one of the gears 100, 102 to freewheel at a time.

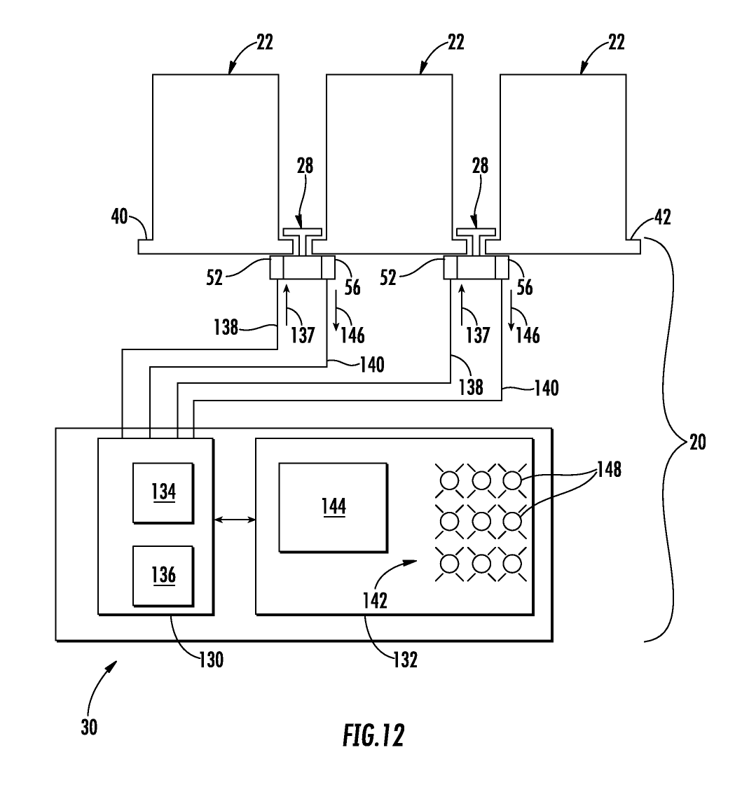

Referring to FIG. 12, the control panel 30 of the cargo restraint system 20 may include a controller 130 and a user interface 132. The controller 130 may include a processor 134 (e.g., microprocessor) and an electronic storage medium 136 that may be computer writeable and readable. The controller 130 may generally communicate with, and send command signals (see arrows 137) to, the electric motors 52 (and/or the local control units 58) over pathways 138, and the controller 130 may communicate with the position sensors 56 over pathways 140. The pathways 138, 140 may be hard wired or wireless. In one embodiment, the controller 130 may send command signals to the local control unit 58 (see FIG. 8) that may then be configured to power the electric motor 52 and generally control the direction of rotation.

The user interface 132 may include a user display 142, and a user input device 144. The user display 142 may generally be controlled by the controller 130 via position signals (see arrows 146) received from the position sensors 56 over pathways 140 and processed by the processor 134. The user display 142 may generally show, or indicate, a position status of the lock-down assemblies 28, and may include a plurality of indicators 148 each associated with a respective one of the lock-down assemblies 28. The indicators 148 may provide the user a remote visual and/or audible indication of which assemblies 28 are in the latched position, which are in the unlatched position, and which may be in a fault condition.

The user input device 144 may be configured to enable the user to place any one, or more, of the lock-down assemblies 28 in the latched position and in the unlatched position. The input device 144 may include the ability to lock and unlock all of the lock-down assemblies 28 in a single action. Examples of the device 144 may be a touch screen, switches, and buttons.

Advantage and benefits of the present disclosure include a cargo restraint system that is generally automated to both restrain and un-restrain multiple cargo containers in what may be a single, remote, action. Another advantage is the remote indication of lock-down assembly positions that may not otherwise be available in crowed, or congested, cargo bays. Other advantages include a compact, robust, and relatively inexpensive design.

While the present disclosure is described with reference to the figures, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A cargo restraint system adapted to lock-down a plurality of cargo containers in a cargo bay, the cargo restraint system comprising:
a plurality of lock-down assemblies each including a structural frame, a first pawl pivotally engage to the structural frame and adapted to pivot about a pivot axis between a latched position for lock-down of at least one of the plurality of cargo containers and an unlatched position, and an electric motor supported by the structural frame and adapted to drive the first pawl between the latched and unlatched positions; and
a control panel configured to control the positioning of the plurality of lock-down assemblies via the respective electric motors.

2. The cargo restraint system set forth in claim 1, wherein the first pawl does not project above the structural frame when in the unlatched position, and projects above the structural frame when in the latched position.

3. The cargo restraint system set forth in claim 2, further comprising:
an elongated tray extending along a centerline, attached to the cargo bay, and generally disposed below the plurality of cargo containers, wherein the plurality of lock-down assemblies are supported by and located in the elongated tray.

4. The cargo restraint system set forth in claim 3, wherein the centerline is disposed perpendicular to the pivot axis of each one of the plurality of lock-down assemblies.

5. The cargo restraint system set forth in claim 4, further comprising:
a plurality of rollers spaced along and rotationally engaged to the tray for rolling upon the plurality of cargo containers, wherein each roller of the plurality of rollers include a rotation axis disposed normal to the centerline.

6. The cargo restraint system set forth in claim 1, wherein each one of the plurality of lock down assemblies include a position sensor configured to output a position signal to the control panel and indicative of the latched and unlatched positions.

7. The cargo restraint system set forth in claim 6, wherein the control panel includes a user display configured to display the latched and unlatched positions of the plurality of lock-down assemblies.

8. The cargo restraint system set forth in claim 1, wherein each one of the plurality of lock down assemblies include a second pawl pivotally engaged to the structural frame, and adapted to pivot with the first pawl between the latched and unlatched positions.

9. The cargo restraint system set forth in claim 8, wherein the first pawl is adapted to lock-down a first cargo container of the plurality of cargo containers when in the latch position, and the second pawl is adapted to lock-down a second cargo container located adjacent to the first cargo container when in the latched position.

10. A cargo lock-down assembly comprising:
a structural frame;
an electric motor supported by the structural frame;
a first pawl pivotally engaged to the structural frame; and
a drive device operably connected between the electric motor and the first pawl for pivoting the first pawl between latched and unlatch position.

11. The cargo lock-down assembly set forth in claim 10, further comprising:
a second pawl pivotally engaged to the structural frame and operably connected to the drive device, and constructed to move with the first pawl between the latched and unlatched positions.

12. The cargo lock-down assembly set forth in claim 11, further comprising:
a position sensor adapted to detect the latched and unlatched positions.

13. The cargo lock-down assembly set forth in claim 10, further comprising:
a roller rotationally engaged to the structural frame about a rotation axis, and projecting in-part above the structural frame.

14. The cargo lock-down assembly set forth in claim 13, wherein the electric motor is disposed radially inward from the roller.

15. The cargo lock-down assembly set forth in claim 14, wherein the electric motor includes a rotor centered to the rotation axis.

16. The cargo lock-down assembly set forth in claim 11, wherein the drive device is a gear train including a first freewheel gear engaged to the first pawl and a second freewheel gear engaged to the second pawl, and the electric motor is constructed to drive the first freewheel gear when moving toward one of the latched and unlatched positions as the second freewheel gear freewheels, and the electric motor is constructed to drive the second freewheel gear when moving toward the other of the latched and unlatched positions as the first freewheel gear freewheels.

17. The cargo lock-down assembly set forth in claim 16, further comprising:
a torsion spring engaged between the first and second pawls and adapted to cause simultaneous pivoting of the first and second pawls between the latched and unlatched positions.

18. The cargo lock-down assembly set forth in claim 11, wherein the electric motor is reversible.
